(19) United States
(12) Patent Application Publication
(10) Pub. No.: US 2013/0305171 A1
(43) Pub. Date: Nov. 14, 2013

(54) INVESTIGATIVE SYSTEM AND METHOD FOR VISUALIZING AND NAVIGATING DYNAMIC RELATIONSHIPS

(71) Applicants: Richard Torgersrud, San Francisco, CA (US); Kevin O'Neil, Parma, ID (US); Christopher Ditto, San Jose, CA (US); Grant Gongaware, San Francisco, CA (US); Kevin E. Krauss, San Francisco, CA (US); Erik Petersen, San Francisco, CA (US)

(72) Inventors: Richard Torgersrud, San Francisco, CA (US); Kevin O'Neil, Parma, ID (US); Christopher Ditto, San Jose, CA (US); Grant Gongaware, San Francisco, CA (US); Kevin E. Krauss, San Francisco, CA (US); Erik Petersen, San Francisco, CA (US)

(73) Assignee: Telmate, LLC, San Francisco, CA (US)

(21) Appl. No.: 13/469,632

(22) Filed: May 11, 2012

(51) Int. Cl. G06F 3/01; G06F 17/30

(52) U.S. Cl. 715/762

(57) ABSTRACT

A system and method of visually representing relationships, such as transactions, communications, associations or other commonalities, between individuals in detention environments (such as prisons or detention facilities) with one or more individuals within or external to such detention environments.

### FIELD

This disclosure relates to an investigative tool and more specifically to a system and method for visualizing and navigating dynamic relationships relating to individuals subject to detention environments (e.g., residing or secured in, or on parole, work release or probation from jails, prisons, detention facilities, secured hospitals or addiction treatment facilities).

### BACKGROUND

With respect to detention environments, such as a jail, prison, detention facility, secured hospital or addiction treatment facility, investigators often have to collect information regarding individuals subject to the detention environment from various sources and compile lists by hand. To extrapolate relationships from that data, investigators have to manipulate this data manually. Due to the increasing implementation of computerized systems, relevant information is growing at a rate where gathering information by hand is becoming unwieldy. As the volume of data increases, important relationships are often obscured. Therefore, there is an ever increasing demand for automated tools for efficiently browsing and retrieving relevant information regarding relationships of individuals who are subject to the detention environment.

Most of the data being gathered at detention environments is dynamic because the individuals in the detention environments are constantly interacting with one another and with individuals outside of the detention environment. It is difficult to determine relationships using dynamic information because the information comes from an ongoing process and must therefore somehow be updated and displayed without causing past information to be indistinguishably clustered together. An improved investigative system and method enabling the visualization and navigation of dynamic relationships is therefore needed.

### SUMMARY

As described more fully below, the embodiments of the present disclosure relate to an investigative tool and more specifically to a system and method for visualizing and navigating dynamic relationships relating to individuals in secure environments.

To this end, a disclosed system and method for implementing an investigative tool is provided. The system comprises a plurality of data gathering systems that gather information relating to individuals subject to a detention environment; a database that processes dynamic information from the data gathering systems and stores the information into a non-transitory machine-readable medium; and a controller that queries the database and dynamically constructs relationships of an individual of interest from the database in order to construct a graphical user interface (GUI) displayable on a display device.

In some embodiments, the system may have the plurality of data gathering systems also gather information relating to individuals who are not within the detention environment.

These, as well as other components, steps, features, objects, benefits, and advantages will now become clear from a review of the following detailed description of illustrative embodiments, the accompanying drawings and the claims. It is to be expressly understood, however, that the drawings, background, summary and descriptions are for the purpose of illustration only and are not intended as a definition of the limits of the claimed embodiments.

### BRIEF DESCRIPTION OF THE DRAWINGS

FIG. 1 is a diagram illustrating one embodiment of the system according to aspects of the present disclosure.

FIG. 2 is a flowchart illustrating one embodiment of the method according to aspects of the present disclosure.

FIG. 3 illustrates an example GUI showing an individual in a detention environment being selected as an individual of interest in accordance with the disclosed principles.

FIG. 4 illustrates an example GUI showing an individual not within or subject to the detention environment being selected as an individual of interest in accordance with the disclosed principles.

FIG. 5 illustrates an example file system navigator GUI in accordance with the disclosed principles.

FIG. 6 illustrates an example network GUI where the individuals are represented as vertices in accordance with the disclosed principles.

FIG. 7 illustrates an example circular relationship GUI in accordance with the disclosed principles.

FIGS. 8A and 8B are example GUIs where it is possible to select individuals and determine the degrees of relationships between the individuals in accordance with the disclosed principles.

FIG. 9 illustrates an example timeline GUI in accordance with the disclosed principles.

### DETAILED DESCRIPTION OF ILLUSTRATIVE EMBODIMENTS

Illustrative embodiments are now discussed. Other embodiments may be used in addition or as alternatives. Details that may be apparent or unnecessary may be omitted to save space or for a more effective presentation. Conversely, it should be appreciated that some embodiments may be practiced without all of the details that are disclosed.

As used herein, an individual is a person, representation of an anonymous or unknown person, or other evidence supporting identity, such as e.g., a phone number, credit card, fingerprint, photographs, social security number, government identification, visitations, financial transactions, gang affiliation, tattoos, traits and utility bills.

As used herein, information may include communications, transactions, and associations between or mutually involving individuals. Communications may include e.g., phone calls, voicemail, electronic messages, video visits, and traditional mail. Transactions may include any financial ties or events, such as e.g., monetary deposits, buying commissary goods, creating or modifying inmate trust fund accounts, bail payments, bond payments, restitution payments, and any other payments, or interactive events, such as e.g., conducting a phone call, conducting a visit, sending or receiving communication. Associations may include direct or indirect affiliations, or commonalities, such as e.g., shared arresting officer, shared gang affiliation, shared jail cell or pod, visitations, a linkage to a common crime or crime scene, a modus operandi, having or conducting shared or similar activity in an external network, site or group, or a family connection.

As used herein, relationships may be connections between and among individuals formed by communications, transactions, and associations.

As used herein, a detention environment is defined as an environment in which individuals are confined with supervision, such as a detention facility, jail, prison, secure hospital, or secure addiction treatment facility.

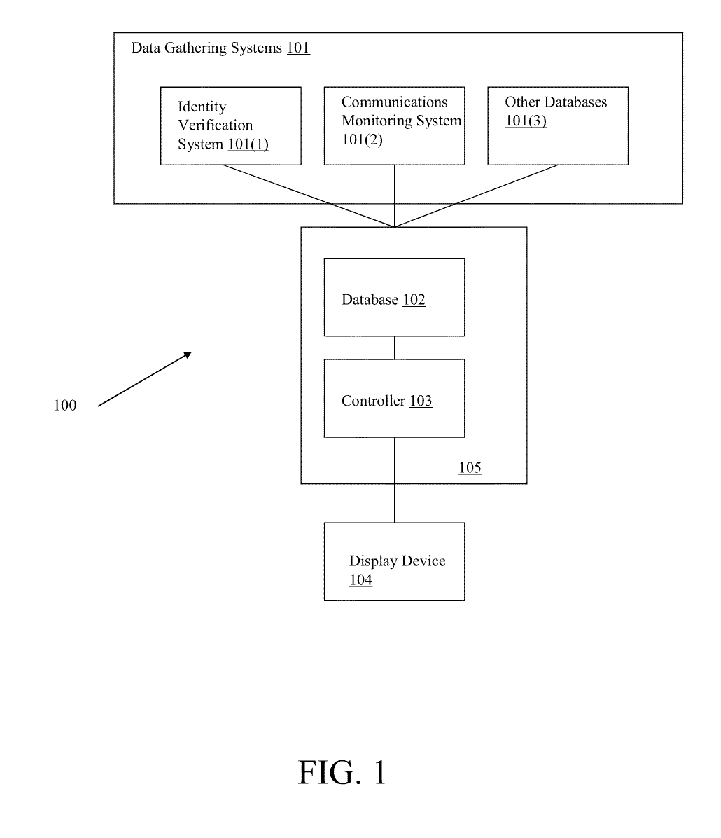

FIG. 1 is a diagram illustrating one embodiment of a system 100 according to aspects of the present disclosure. The system 100 is designed for use within a detention environment or as part of a system monitoring a detention environment. The system 100 has a server 105 that gathers information from a plurality of data gathering systems 101. The data gathering systems 101 may include an identity verification system 101(1), a communication monitoring system 101(2), or other databases 101(3) found in or used with a detention environment network. These data gathering systems 101 may collect information about communications, transactions, and associations relating to an individual in a detention environment.

The system 100 is preferably compatible with a data gathering system such as e.g., the interactive audio/video system and device for use in a detention environment disclosed in U.S. patent application Ser. No. 13/088,883, which is incorporated by reference herein. The system 100 is also preferably compatible with a data gathering system such as the consolidated voicemail platform disclosed in U.S. patent application Ser. No. 12/826,168, which is incorporated by reference herein. The system 100 is also preferably compatible with an information exchange facilitating system such as e.g., the secure social network disclosed in U.S. patent application Ser. No. 13/438,940, which is incorporated by reference herein. It should be appreciated that where a definition or use of a term in an incorporated application or reference is inconsistent with or contrary to the definition of that term provided herein, the definition of that term provided herein applies.

The server 105 includes a controller 103 and a database 102 and parses the information before storing it in the database 102. The controller 103 queries the database 102 to retrieve the information and build relationships about an individual of interest from the information. The controller 103 uses the relationships to construct a graphical user interface (GUI) that is output to a display device 104 (e.g., a computer monitor or other display screen or rendering device) so that an investigator, administrator, a user or other personnel can view and/or manipulate the information.

In one embodiment, the data gathering systems 101 may send information to the database 102 whenever new information is gathered. In another embodiment, the database 102 may pull data from the data gathering system 101 periodically and/or upon command.

In one embodiment, the database 102 may notify the controller 103 whenever it receives new information so that the controller 103 can query the information and update a previously created GUI with new relationships. In another embodiment, the controller 103 may pull data from the database 102 periodically and/or upon command.

Alternatively, the controller may implement a process that issues a warning about an individual based on predefined criteria, such as e.g., suspiciously large or frequent monetary deposits, or an unusually large number of relationships to any individual.

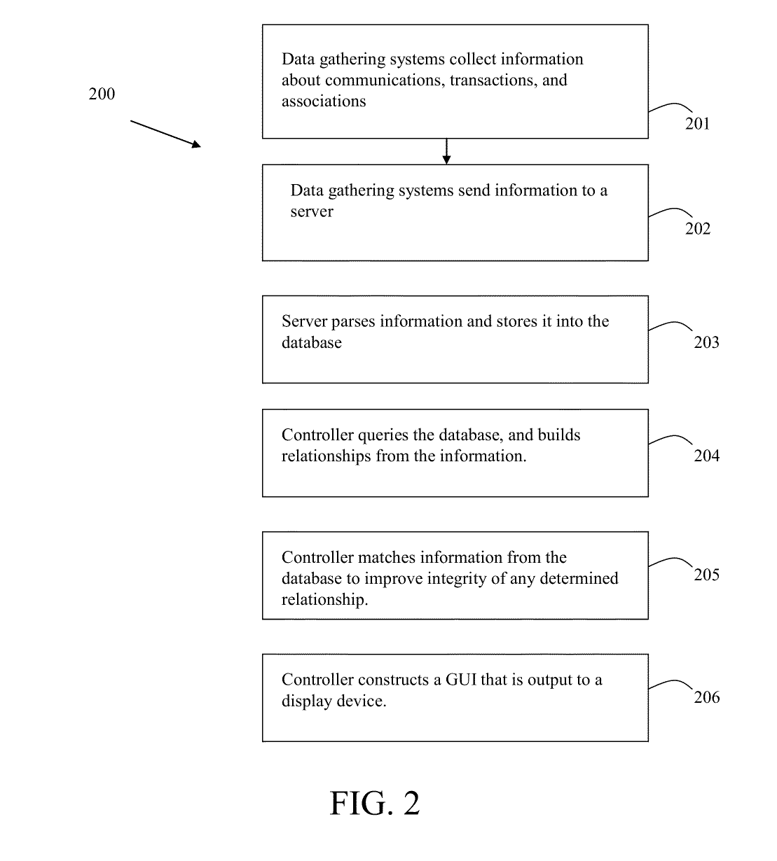

FIG. 2 is a flowchart illustrating one embodiment of a method 200 according to aspects of the present disclosure. At step 201, the data gathering system collects information about communications, transactions, and associations. At step 202, the data gathering system sends information to a server (e.g., server 105). At step 203, the server parses the information and stores it into a database (e.g., database 102). The server's controller (e.g., controller 103) queries the database and builds relationships from the information (at step 204). At step 205, the controller matches information from the database to improve integrity of any determined relationship. For example, the controller may discover that there are two J. Does communicating with an individual from the same phone number. The controller may check the database to determine whether the J. Does are two separate people, such as e.g., John Doe and Jane Doe, or simply one person. At step 206, the controller constructs a GUI to be output to a display device (discussed below in more detail).

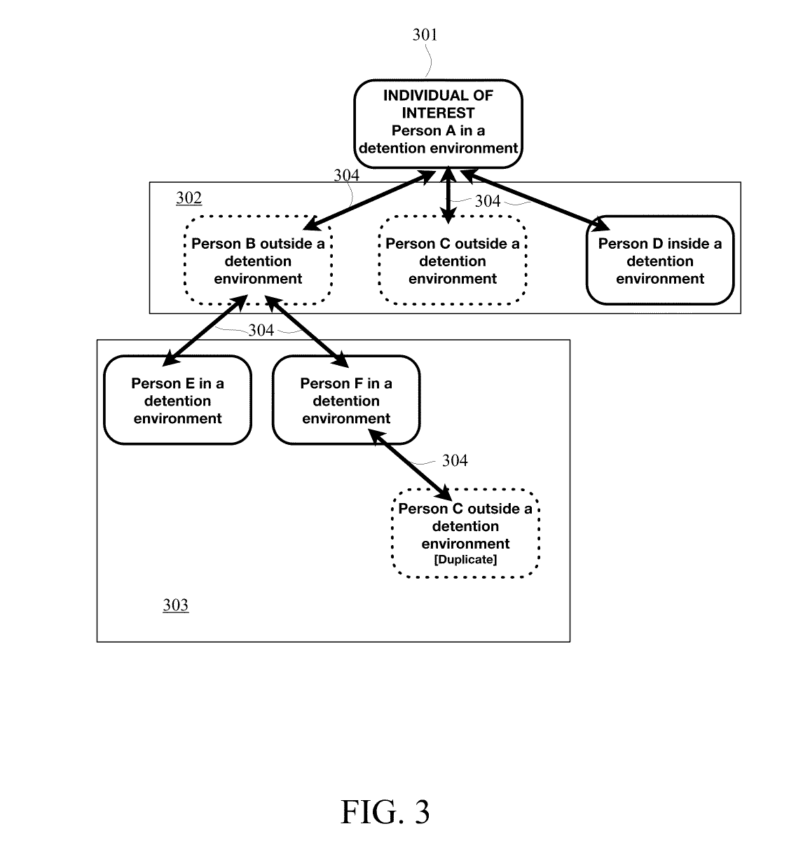

FIG. 3 illustrates an example GUI 300 illustrating how an individual in a detention environment is selected as an individual of interest 301. An “individual of interest” is identified as the starting node for the controller. In a simple implementation, the GUI 300 may resemble a tree or organizational chart where nodes 302 representing an individual are connected by lines to represent relationships 304. Additionally, in the GUI 300, each node 302 displays the relationships that it has with the other nodes. Additionally, more distant nodes 303 may appear in the GUI to represent relationships 304 further removed from the individual of interest 301. A user would be able to send requests to the controller to either change the point of focus by expanding, contracting, or changing the GUI, or transform the GUI by switching between any type of GUI as illustrated in FIGS. 3-9 (discussed below in more detail).

For GUIs 300 that are complex, a filtering feature may be used to reduce results to reveal only relationships that are relevant to a particular inquiry. A user who only wishes to investigate a particular type of relationship such as e.g., financial transactions between individuals within a specific time period may choose to only display relationships involving financial transactions. Filtering may also include limiting results to connection type, frequency, time frame, and or geographic location. A relationship type might be a general type such as a communication, or more specific type such as a voicemail, connected phone call, attempted but not completed phone call, or in-person visitation. Filtering by frequency may include e.g., filtering for a certain number of relationships that may only display individuals connected by two or more financial transactions. Filtering by time frame may include e.g., limiting results to display relationships that occurred within one or more specified time frames such as relationships occurring or ongoing only in the month of October. Filtering by geographic location may involve e.g., limiting results to a specific area, calls to a destination number within a particular state, or visits from persons who reside in the same county.

When viewing a relationship, an individual may appear to warrant additional attention. In this case, selecting an individual who is not the primary individual of interest 301, recreates the GUI with this new individual as the new individual of interest 301; this allows an investigator to quickly change the focus of an investigation and view individuals who are related to the new individual of interest.

Relationships between people subject to a detention environment and others subject to a detention environment could span different secured facilities. For example, if an inmate in one detention environment were to write a letter to an inmate in another detention environment, and the data was tracked within one of the data gathering system 101, those two inmates would share a relationship.

The system 100 may receive requests from the user to manipulate the GUI for a variety of results. For example, the system 100 may receive a request to change the point of focus by expanding, contracting, or changing the GUI, or transform the GUI to alternate between the different GUI as illustrated in FIGS. 3-9.

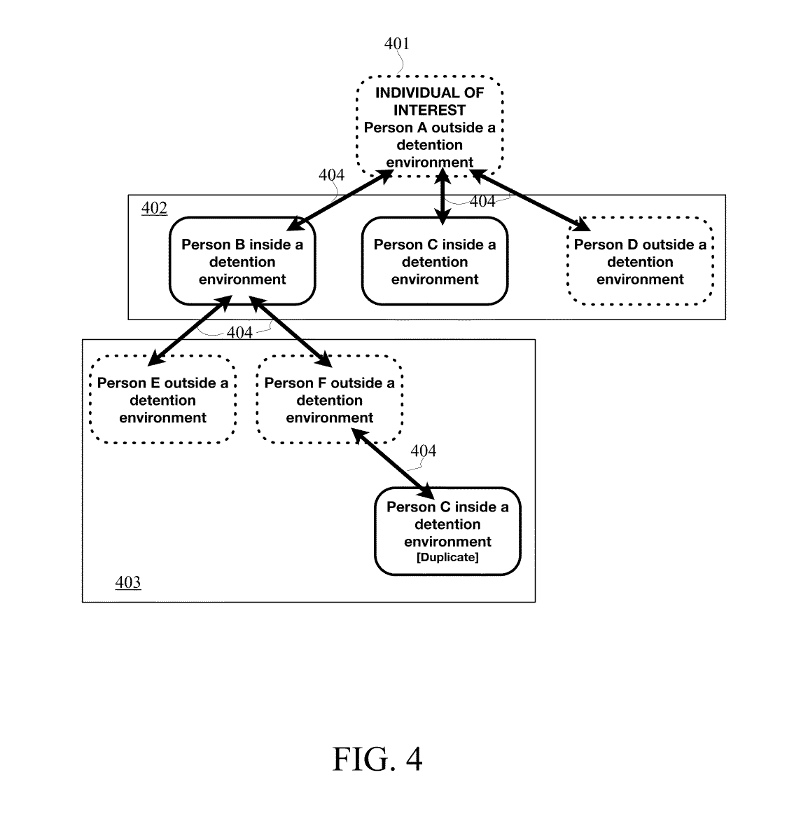

FIG. 4 illustrates an example GUI 400 illustrating an individual selected as an individual of interest 401, wherein the individual is not subject to the detention environment (e.g., a family member, attorney, an individual associated with a phone number, or anonymous depositor). The GUI 400 can show many degrees of relationships such as e.g., relationships 404 with individuals 402 immediately related to the individual of interest 401, and indirect relationships 403 to the person of 401. The GUI 400 may expand to show deeper layers of relationships. The images on the GUI may also be contracted to hide relationships that are or are perceived to be less direct, less relevant, less important, or otherwise of less interest. For example, a default GUI 400 may show an individual of interest 401, along with all direct relationships 402. A user who wishes to see more detail may expand any of the direct relationships 402 to see additional next-level relationships 403, such individuals who are connected to the individual of interest 401 via two or more degrees of separation.

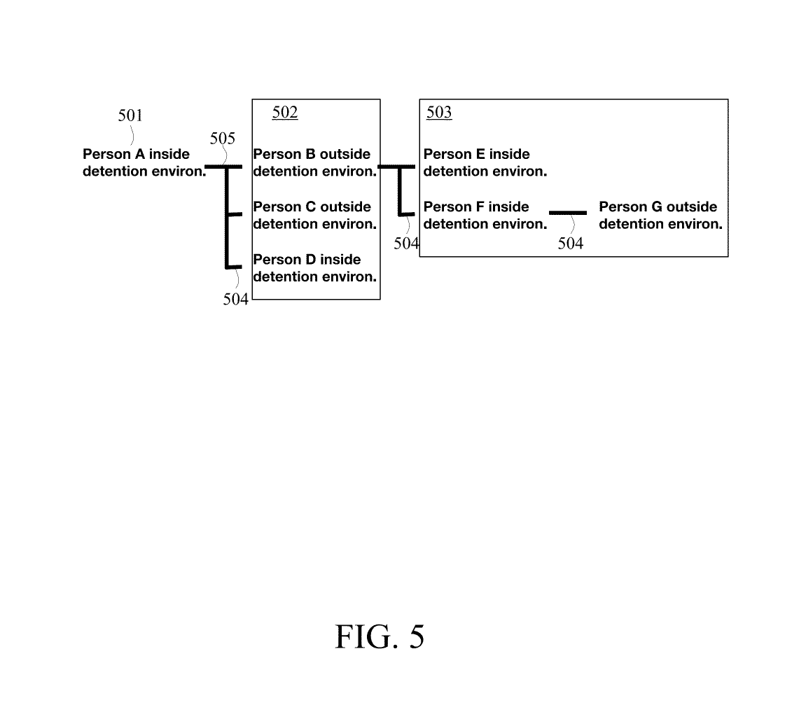

FIG. 5 illustrates an example file system navigator GUI 500 that may be displayed to a user. Graphical displays of relationships may be very complex with very large numbers of individuals represented. Because of this, a GUI 500 starting with an individual of interest 501 may be expanded to show only one relationship degree 502 or a few degrees 503 of relationships with each endpoint 505 being expandable to show additional relationships 504 for that individual. This GUI may show only a small portion of the related nodes at any one time. Likewise, a user benefits from a mechanism that allows relationships to be contracted, such as e.g., to hide a surfeit of relationships that distract from more perceived relevant relationships.

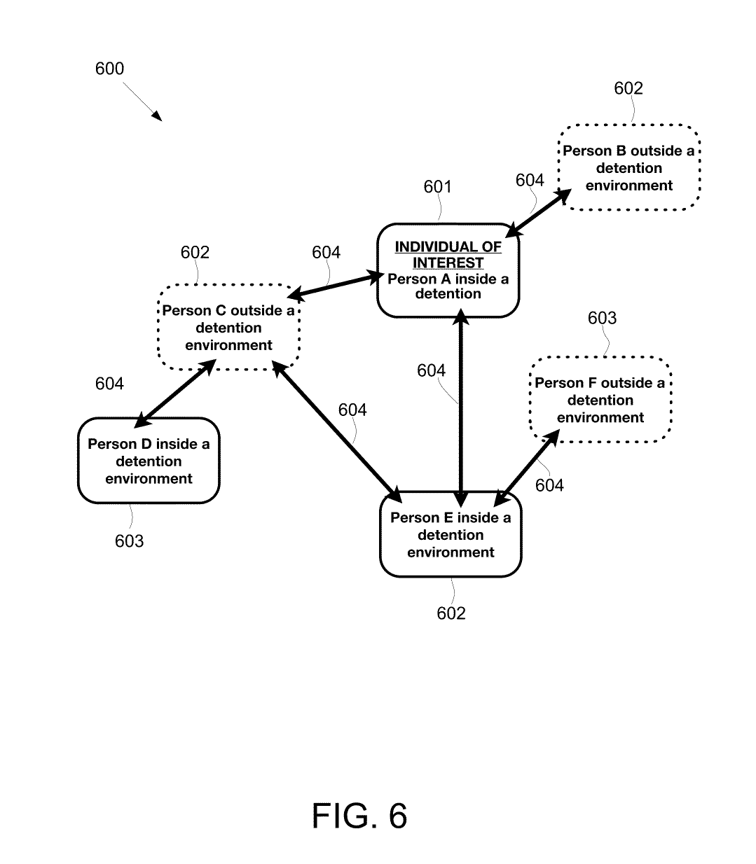

FIG. 6 illustrates a network GUI 600 that may be displayed to a user where the individuals are represented as vertices. A collection of lines, known as arcs, represents relationships 604 and connects nodes together based on their relationships. This allows a user to see whether an individual 602 is immediately related to the individual of interest 601, and/or if there are degrees of separation between an individual 603 and the individual of interest 601.

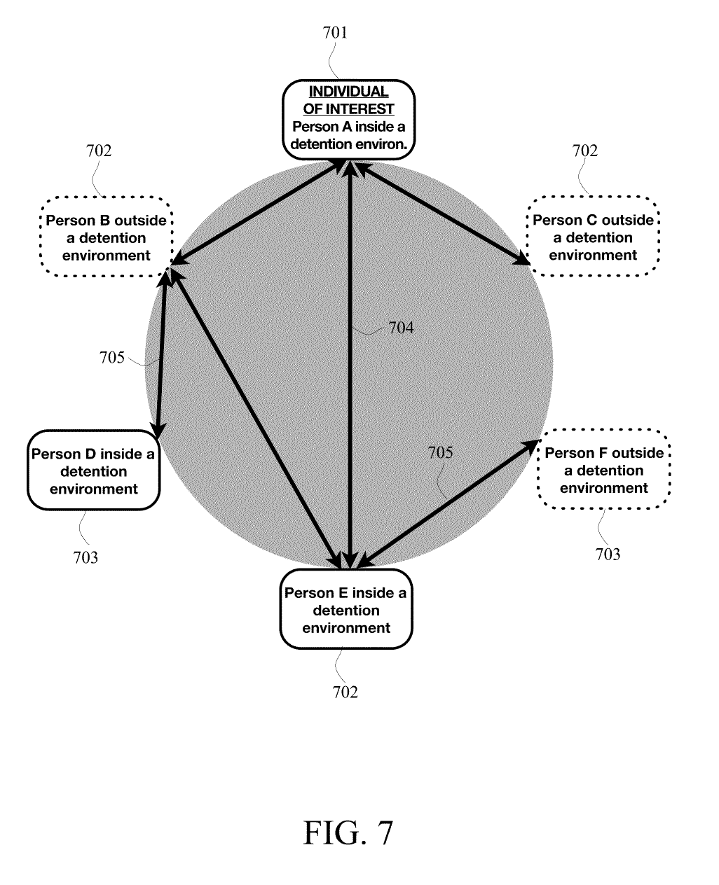

FIG. 7 illustrates a circular relationship GUI 700 that may be displayed to a user. An individual of interest 701 is selected, and a circular relationship is displayed where lines representing relationships 704 connect the individual of interest 701 to the closest related individuals 702. This GUI also displays the various degrees between individuals 703 and the individual of interest 701.

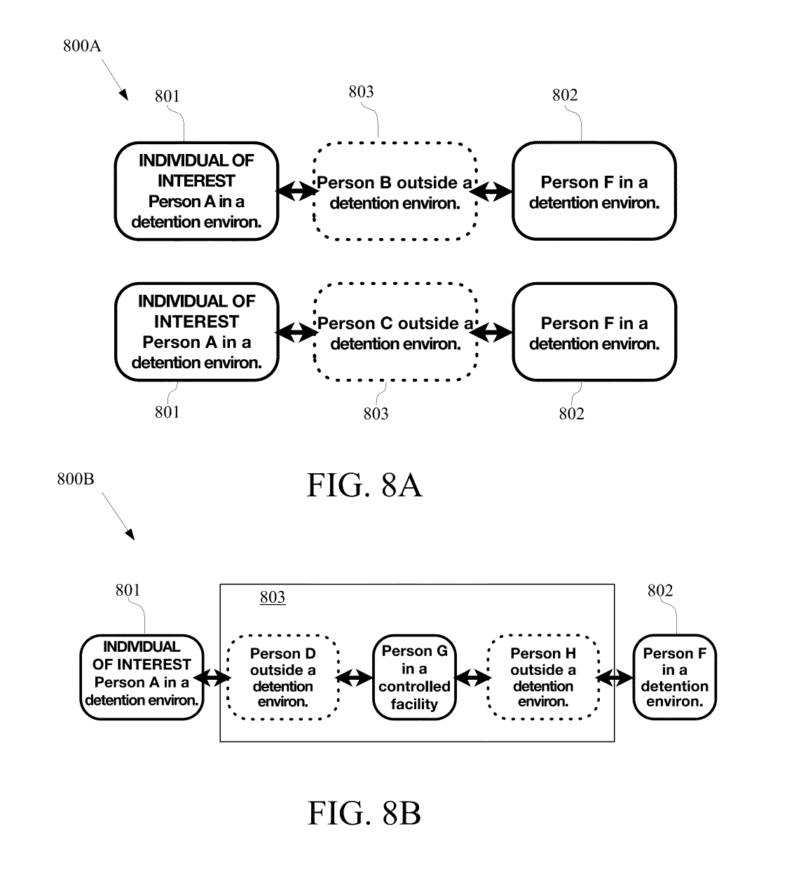

FIG. 8A illustrates another GUI 800A that may be displayed to a user where it is possible to reveal relationships between specific individuals. It is possible to select an individual of interest 801 and another individual 802. The controller produces a GUI that focuses on the selected individuals and displays the paths that link them together 803. This aids in focusing on the degrees of separation between selected individuals. In the case shown in FIG. 8A, there is only one degree 803 of separation between two individuals, i.e., the individual of interest 801 and another individual 802.

FIG. 8B illustrates a GUI 800B where an individual of interest 801 and another individual 802 are selected. The controller produces a GUI that displays the paths that link them together 803. In the case shown in FIG. 8B, there are three degrees of separation.

To find relationships shared by multiple members of a group, it is possible to provide a list of individuals and receive a visual display of relationships to other individuals that the provided group may have in common. For example, if five suspected gang members are provided as a starting point, the system might display a common relationship between all members of the group and a single outside individual who has deposited funds for some in the group and received phone calls from others in the group.

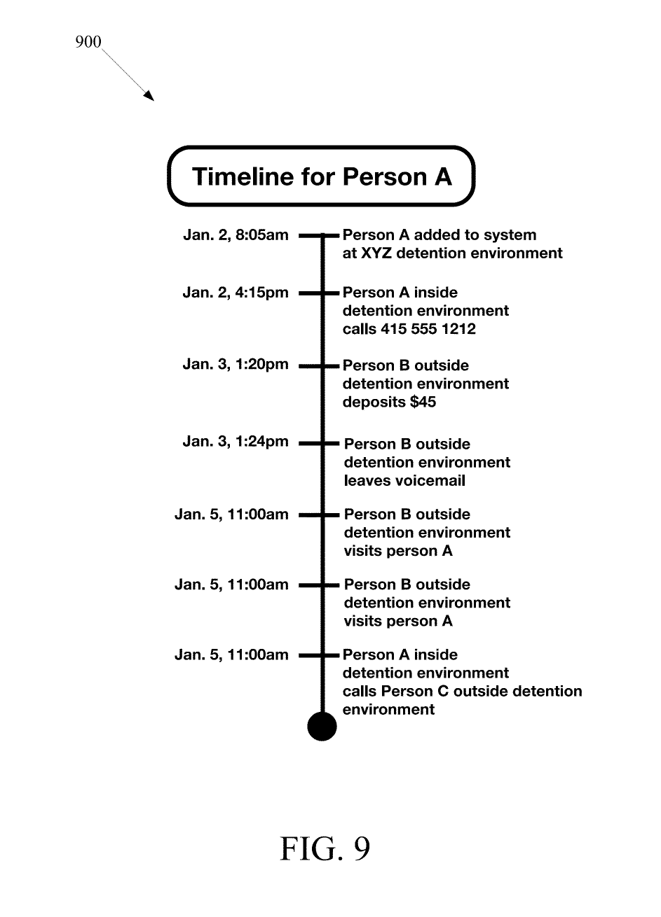

FIG. 9 illustrates a timeline GUI 900 that may be displayed to a user where relationships between the individual of interest and other individuals are represented in chronological order.

In accordance with the practices of persons skilled in the art of computer programming, embodiments of the method 200 are described with reference to operations that are performed by a computer system or a like electronic system. Such operations are sometimes referred to as being computer-executed. It will be appreciated that operations that are symbolically represented include the manipulation by a processor, such as a central processing unit, of electrical signals representing data bits and the maintenance of data bits at memory locations, such as in system memory, as well as other processing of signals. The memory locations where data bits are maintained are physical locations that have particular electrical, magnetic, optical, or organic properties corresponding to the data bits. Embodiments may also encompass integrated circuitry including circuit elements capable of performing specific system operations.

When implemented in software, the elements of the embodiments are essentially the code segments to perform the necessary tasks. The non-transitory code segments may be stored in a processor readable medium or computer readable medium, which may include any medium that may store or transfer information. Examples of such media include an electronic circuit, a semiconductor memory device, a read-only memory (ROM), a flash memory or other non-volatile memory, a floppy diskette, a CD-ROM, an optical disk, a hard disk, a fiber optic medium, etc. User input may include any combination of a keyboard, mouse, touch screen, voice command input, etc. User input may similarly be used to direct a browser application executing on a user's computing device to one or more network resources, such as web pages, from which computing resources may be accessed.

While the invention has been described in connection with specific examples and various embodiments, it should be readily understood by those skilled in the art that many modifications and adaptations of the invention described herein are possible without departure from the spirit and scope of the invention as claimed hereinafter. Thus, it is to be clearly understood that this application is made only by way of example and not as a limitation on the scope of the invention claimed below. The description is intended to cover any variations, uses or adaptation of the invention following, in general, the principles of the invention, and including such departures from the present disclosure as come within the known and customary practice within the art to which the invention pertains.

What is claimed is:

1. A system for implementing an investigative tool, said system comprising:
a plurality of data gathering systems that gather information relating to individuals subject to a detention environment;
a database that processes dynamic information from the data gathering systems and stores the information into a non-transitory machine-readable medium; and
a controller that queries the database and dynamically constructs relationships of an individual of interest from the database in order to construct a graphical user interface (“GUI”) displayable on a display device.

2. The system of claim 1, wherein the plurality of data gathering systems also gather information relating to individuals who are not subject to the detention environment.

3. The system of claim 1, wherein the individual of interest is selected as a starting point for the controller to construct the GUI.

4. The system of claim 1, wherein the controller implements a process to issue a warning regarding an individual based on predefined criteria to alert a user of the system.

5. The system of claim 1, wherein the controller receives requests and manipulates the GUI based on the request.

6. The system of claim 5, wherein the received request is a request to expand, contract, or change the point of focus in the GUI.

7. The system of claim 5, wherein the received request is a request to limit types of relationships displayed in the GUI.

8. The system of claim 5, wherein the received request is a request to transform the GUI into a hierarchical GUI, network GUI, circular relationship GUI or chronological GUI.

9. The system of claim 5, wherein the received request is a request to transform the GUI to focus on specified individuals to reveal the degrees of separation between them.

10. The system of claim 5, wherein the received request is a request to display individuals who share common information in the GUI.

11. A method embodied in a computer program comprising non-transitory program instructions that, when executed by a processor, cause the processor to:
process dynamic information from a plurality of data gathering systems, wherein the information relates to individuals in a detention environment;
store the information in a database;
query the database and dynamically construct relationships of an individual of interest from the database; and
display a graphical user interface (“GUI”) displaying the individual of interest and the individual of interest's relationships.

12. The method of claim 11, wherein the plurality of data gathering systems also gather information relating to individuals who are not subject to the detention environment.

13. The method of claim 11, wherein the individual of interest is selected as a starting point for the controller to construct the GUI.

14. The method of claim 11, further comprising issuing a warning regarding an individual based on predefined criteria.

15. The method of claim 11, further comprising receiving a request and manipulating the GUI based on the request.

16. The method of claim 15, wherein the received request is a request to expand, contract, or change the point of focus in the GUI.

17. The method of claim 15, wherein the received request is a request to limit types of relationships displayed in the GUI.

18. The method of claim 15, wherein the received request is a request to transform the GUI into a hierarchical GUI, network GUI, circular relationship GUI, or chronological GUI.

19. The method of claim 15, wherein the received request is a request to transform the GUI to focus on specified individuals to reveal the degrees of separation between them.

20. The method of claim 15, wherein the received request is a request to display individuals who share common information in the GUI.
